(19) United States
(12) Patent Application Publication
(10) Pub. No.: US 2020/0328653 A1
(43) Pub. Date: Oct. 15, 2020

(54) DEVICE FOR LOCKING A SHAFT OF AN ELECTRIC MOTOR

(71) Applicant: WITTENSTEIN SE, Igersheim (DE)

(72) Inventors: Ingolf Gröning, Bad Mergentheim (DE); Thomas Bayer, Igersheim (DE)

(73) Assignee: WITTENSTEIN SE, Igersheim (DE)

(21) Appl. No.: 16/846,523

(22) Filed: Apr. 13, 2020

(30) Foreign Application Priority Data
Apr. 15, 2019 (DE) 102019109912.9

(51) Int. Cl. H02K 7/102; F16D 63/00; F16D 65/16

(52) U.S. Cl. CPC H02K 7/102; F16D 2121/22; F16D 65/16; F16D 63/006

(57) ABSTRACT

Apparatus for locking a shaft of an electric motor includes a gear wheel (5) which is arranged on the shaft, at least two movable pins, and a pin carrier (11) with at least two guides (13) for in each case one pin, wherein in each case precisely one pin is received in a movable manner in at least two of the guides (13), wherein the pin carrier (11) is formed at least substantially coaxially in relation to the shaft, and wherein the guides (13) are oriented in such a way that the pins can be positioned in a manner extended in the respective guides for engagement with the gear wheel (5).

### BACKGROUND OF THE INVENTION

The invention relates to an apparatus and to a method for locking a shaft of an electric motor.

The prior art discloses spring-force brakes which are embodied as holding brakes or emergency brakes for motors. A spring-force brake comprises, for example, a disk which is mounted on a shaft of a motor and has a friction lining, a friction partner which is prestressed with respect to the disk by a spring, and an electromagnet. When current is flowing through the electromagnet, the friction partner can be separated from the disk against the force of the spring, and when no current is flowing through the electromagnet the friction partner is pushed onto the disk by the spring, as a result of which the disk is braked or stopped.

However, prior-art solutions known to date are limited in terms of the braking torque or holding torque which can be transmitted, in particular on account of the transmission of torque by friction.

### SUMMARY OF THE INVENTION

The object of the invention is to specify apparatuses for locking a shaft of an electric motor which are improved in comparison to apparatuses known from the prior art. In particular, the intention is to specify apparatuses which provide a higher transmittable torque or an adjustable, transmittable torque or transmit a torque by interlocking connection given the same installation space. Here and below, a torque is understood to mean, in particular, a braking torque or a holding torque.

The object is achieved by an apparatus as disclosed herein and a method for locking or releasing a shaft of an electric motor also as disclosed herein. Advantageous developments and embodiments can be found in the dependent claims and in this description.

One aspect specifies an apparatus for locking a shaft of an electric motor, comprising a gear wheel which is arranged on the shaft, at least two movable pins, and a pin carrier with at least two guides for in each case one pin, wherein in each case precisely one pin is received in a movable manner in at least two of the guides, wherein the pin carrier is formed at least substantially coaxially in relation to the shaft, and wherein the guides are oriented in such a way that the pins can be positioned in a manner extended in the respective guides for engagement with the gear wheel.

A further aspect of the invention relates to a method for locking or releasing a shaft of an electric motor using an apparatus according to one of the embodiments described herein by moving the teeth.

In typical embodiments, the pin carrier is connected in a rotationally fixed manner to a static element of the electric motor, i.e. in a rotationally fixed manner with respect to a stator of the electric motor. The pin carrier is typically connected, for example adhesively bonded or screwed, in a rotationally fixed manner to an electric motor housing of the electric motor, wherein the electric motor housing can comprise a yoke, a closure ring or an end plate.

The gear wheel is typically connected to a shaft of the electric motor, for example screwed or clamped to the shaft by means of a clamping screw, in particular by means of a clamping screw and keyways, in a rotationally fixed manner. The gear wheel typically has an encircling tooth system. The tooth system of the gear wheel typically has a regular tooth pitch with a gear wheel pitch angle. The gear wheel pitch angle is calculated by dividing 360° by the number of teeth of the gear wheel.

In typical embodiments, the pin carrier is embodied in an annular manner. The pin carrier is typically arranged coaxially in relation to the gear wheel, in particular coaxially in relation to the longitudinal axis of the shaft of the electric motor. In typical embodiments, the pin carrier has a radial recess, the diameter of which corresponds at least to the outside diameter of the shaft of the electric motor.

Typically, the pins can be positioned in a manner retracted in the guides, wherein the pins are not in engagement with the gear wheel in a retracted position, and can be positioned in an extended manner, wherein the pins are extended in the respective guides toward the gear wheel for engagement with the gear wheel in an extended position.

In typical embodiments, the pins are designed as teeth with tooth flanks. The tooth flanks of the teeth form a tapered portion at that end of the teeth which faces the gear wheel. The teeth are typically embodied as individual teeth, in particular the teeth typically have two tooth flanks. Each tooth which is received in a guide of the pin carrier in a movable manner typically has in each case one movement axis along which the tooth is movable. The teeth are typically movable along the guides of the pin carrier.

In typical embodiments, the pins are produced from a metal. The pins are typically embodied in a flexurally rigid manner. Here, the term “flexurally rigid” is typically to be understood in technical terms, that is to say that, owing to the rigidity of the material of the pins, bending of the pins is so slight that it is at least substantially insignificant to the functioning of the apparatus. In further embodiments, the pins, the pin carrier or the gear wheel or a plurality of all of these elements are produced from plastic.

In typical embodiments, the tooth flanks of the teeth are in contact with flanks of the tooth system of the gear wheel in the event of engagement. In the event of engagement, one tooth flank of one tooth and one flank of the tooth system, which are in contact with one another, typically have at least substantially the same inclination with respect to the movement axis of the tooth. This can produce surface contact between the tooth flank of the tooth and the flank of the tooth system, wherein the surface contact can render possible for transmission of a braking torque by means of a surface load.

In typical embodiments, the outer contour of the tooth flanks of the teeth or the outer contour of the tooth system of the gear wheel or both of these contours follows/follow a logarithmic spiral at least in in each case one subregion. This can render possible the transmission of relatively high torques.

In typical embodiments, at least in each case one of the tooth flanks of at least two of the teeth are in contact with flanks of the tooth system in the event of engagement of the teeth with the gear wheel, wherein the at least two of the teeth are in contact with the corresponding flanks of the tooth system in such a way that holding torques are produced in both rotation directions of the gear wheel. Tooth flanks of at least two of the teeth are typically in contact with flanks of the tooth system in such a way that a relative movement between the gear wheel and the pin carrier is not possible. In particular, contact of a first tooth flank of a first tooth with a first flank of the tooth system prevents a relative movement of the gear wheel and the pin carrier in a first rotation direction and contact of a second tooth flank of a second tooth with a second flank of the tooth system prevents a relative movement of the gear wheel and the pin carrier in a second rotation direction. In particular, a relative movement of the gear wheel and the pin carrier can be prevented irrespective of the rotation position of the gear wheel in the event of engagement of the teeth with the gear wheel.

In typical embodiments, teeth which are adjacent, in particular are adjacent along the circumference of the gear wheel, and are arranged in the guides of the pin carrier are separated by difference angles with respect to the center of the gear wheel. The difference angle is typically greater than the gear wheel pitch angle. In typical embodiments, the teeth are distributed at least substantially uniformly in the pin carrier. In particular, adjacent teeth are typically spaced apart at least substantially equally. Adjacent teeth are typically separated by regular difference angles, wherein, in particular, the difference angle is not an integer multiple of the gear wheel pitch angle.

In further typical embodiments, the difference angles between adjacent guides with teeth arranged therein are not regular. In particular, at least one first difference angle differs from at least one second difference angle, wherein the deviation is at most one gear wheel pitch angle of the gear wheel.

In further embodiments with irregular difference angles, teeth are arranged in pin carrier positions which are distributed at regular intervals in the pin carrier, wherein not every pin carrier position is fitted with a tooth. In this case, the pin carrier positions themselves are to be understood only as theoretical auxiliary constructions, i.e. pin carrier positions which are not fitted with guides or teeth are typically not identifiable in the pin carrier. Adjacent pin carrier positions are separated by a position difference angle with respect to the center of the gear wheel, wherein the position difference angle is calculated by dividing 360° by the number of pin carrier positions in the pin carrier. In typical embodiments, the position difference angle is not an integer multiple of the gear wheel pitch angle.

In typical embodiments, the apparatus has a coil which is arranged such that at least one of the teeth can be moved in the respective guide due to current flow in the coil. The tooth can typically be moved to at least one position, in particular to a retracted position or to an extended position, due to current flow. In typical embodiments, all movable teeth can be moved at the same time due to current flow in the at least one coil.

In typical embodiments, the guides which are fitted with the teeth are assigned in each case one coil for moving the tooth in the respective guide. In typical embodiments, in each case one coil surrounds one guide. In typical embodiments, the pin carrier comprises one coil carrier for each guide. Typically, in each case one coil is accommodated in the coil carriers. The coil carriers typically each form a portion of the guide of a tooth.

In further typical embodiments, the apparatus comprises a yoke, in particular an annular yoke, which is arranged coaxially with the pin carrier or the longitudinal axis of the shaft of the electric motor. In typical embodiments, in each case one coil for moving the respective tooth is fastened in or on the yoke for each guide in the pin carrier with a tooth arranged therein.

In further typical embodiments, a coil is arranged coaxially with the pin carrier, in particular on or in a yoke, and is provided for moving all of the teeth which are arranged in a movable manner in the guides of the pin carrier.

In typical embodiments, a spring, which prestresses the tooth in a movement direction of the tooth, is arranged or provided in particular on a guide which is fitted with a tooth. A tooth is typically prestressed in one of the movement directions along the movement axis of the tooth. In typical embodiments, the spring is a helical spring. The spring is typically supported on the pin carrier, in particular on a coil carrier, at one end and on the tooth, in particular on a tooth base of the tooth, at the other end. The tooth base is understood to mean that end of the tooth which is opposite the tooth flanks of the tooth. The tooth base can comprise a tooth projection, i.e. a widened portion of the tooth at the tooth base.

In typical embodiments, the tooth is prestressed by the spring to the extended position. A coil is typically embodied such that the tooth is moved or held against the prestress by the spring, for example is moved to the retracted position and held in the retracted position, when current is flowing through the coil. When no current is flowing through the coil, the tooth is typically in the extended position, in particular in engagement with the gear wheel. Embodiments of this kind are typically referred to as “electrically opening”, i.e. that the apparatus does not create any torque on the gear wheel or a shaft of an electric motor when electric current is flowing through the coil.

In further typical embodiments, the tooth is prestressed by the spring to the retracted position. A coil is typically embodied such that the tooth is moved to the extended position and held in the extended position, in particular in engagement with the gear wheel, when current is flowing through the coil. When no current is flowing through the coil, the tooth is typically in the retracted position. Embodiments of this kind are typically referred to as “electrically closing”, i.e. that the apparatus can create torque on the gear wheel or a shaft of an electric motor when electric current is flowing through the coil.

In typical embodiments, the apparatus has at least two or at least four teeth which are arranged in respective guides. In further typical embodiments, the apparatus has at least six, in particular at least ten, teeth which are arranged in respective guides. The apparatus typically has at most 20 teeth which are arranged in respective guides. In further typical embodiments, a maximum number Z of teeth in the pin carrier is dependent on the number N of teeth of the gear wheel. In particular, the maximum number Z of teeth is:

Z=N/2−1

In typical embodiments, the teeth have magnetic properties. The teeth typically have permanent-magnet or ferromagnetic properties. On account of magnetic properties, a tooth can be moved due to current flow through a coil. Depending on the magnetic property, a tooth can be drawn to the coil, drawn into the coil or pushed away from the coil due to current flow through a coil.

In typical embodiments, the teeth are secured against rotation about their movement axis. A guide of the pin carrier or a coil carrier of the pin carrier typically each have a rotation-prevention pin. The rotation-prevention pin typically runs along the movement axis of a tooth or transversely to the movement axis of a tooth, wherein the tooth has a cutout which corresponds to the rotation-prevention pin, in particular on the tooth base. In typical embodiments, a rotation-prevention pin, which is embodied along the movement axis of a tooth, is surrounded by a spring radially on the outside with respect to the movement axis of the tooth.

In typical embodiments, the guides are oriented radially with respect to the shaft and/or the gear wheel is externally toothed. The guides in the pin carrier, the teeth which are arranged in the guides, and the tooth system of the gear wheel are typically oriented radially with respect to the longitudinal axis of the shaft of an electric motor. The pin carrier is typically embodied in a manner encircling the gear wheel.

In further typical embodiments, the guides are oriented axially or parallel to the shaft and/or the gear wheel is a face gear. The guides in the pin carrier, the teeth which are arranged in the guides, and the tooth system of the gear wheel are typically oriented axially with respect to the longitudinal axis of the shaft of an electric motor which drives the gear wheel. The pin carrier is typically arranged axially along the shaft in a manner offset in relation to the gear wheel.

Typical embodiments comprise an electric motor comprising an apparatus according to one of the typical embodiments described herein. Typically, a converter supplies the apparatus with energy. The apparatus is typically arranged on the B-side of the electric motor. The apparatus is typically connected, for example screwed, to an end plate of the electric motor or to a motor housing of the electric motor by a joining process. In typical embodiments, the gear wheel of the apparatus is arranged on the shaft on or close to the B-side end of the shaft of the electric motor and is connected in a rotationally fixed manner to the shaft by a joining process, for example fastened by means of a clamping screw and keyways.

In typical embodiments, the electric motor is a permanent-magnet synchronous motor.

In typical methods for locking or releasing a shaft, the teeth are moved by electrically excited magnetic fields, in particular against the return force of a spring. In typical embodiments, all teeth of the apparatus are moved at least substantially at the same time.

An electrically opening apparatus is used in typical embodiments of the method. When a current flow through the coil is switched on, the shaft is released due to the teeth moving to a retracted position. When the current flow through the coil is switched off, the shaft is locked due to the teeth moving to an extended position on account of the return force of a spring.

An electrically closing apparatus is used in further typical embodiments of the method. When a current flow through the coil is switched on, the shaft is locked due to the teeth moving to an extended position. When the current flow through the coil is switched off, the shaft is released due to the teeth moving to a retracted position on account of the return force of a spring.

One advantage of typical embodiments over prior art apparatuses is the increase in the transmittable torque, in particular a holding torque or braking torque, given the same installation space, in particular by a factor of five to ten. In typical embodiments, torques can be imparted by interlocking connection, as a result of which the dependency on friction partners is at least reduced. The force which moves the pins to the extended position is typically not in the force flow of the torques which are transmitted between the gear wheel and the pin carrier. One advantage of typical embodiments can be that the guides of the teeth, which guides are arranged in the pin carrier, absorb the forces which are required for locking the shaft. A further advantage results from the surface contact between tooth flanks of the teeth and flanks of the tooth system, as a result of which torques can be transmitted by means of a surface load. A further advantage of typical embodiments can be an adjustable torque. In particular, the torque can be scaled by adjusting the current intensity on the coils. The locking speed can typically be adjusted by adjusting the current intensity on the coils. Furthermore, a direction dependency of transmittable torques can be realized in typical embodiments.

### BRIEF DESCRIPTION OF THE DRAWINGS

The invention will be explained in more detail below with reference to the appended drawings, in which:

FIG. 1 schematically shows a sectional view through an embodiment of the apparatus with an externally toothed gear wheel;

FIG. 2A schematically shows a sectional view through a detail of an embodiment of the apparatus with an externally toothed gear wheel;

FIG. 2B schematically shows a sectional view through a detail of a further embodiment of the apparatus with an externally toothed gear wheel;

FIG. 2C schematically shows a sectional view through a detail of a further embodiment of the apparatus with an externally toothed gear wheel;

FIG. 3 schematically shows a sectional view through an embodiment of the apparatus with a face gear as a gear wheel;

FIG. 4A schematically shows a sectional view through a detail of an embodiment of the apparatus with a face gear as a gear wheel;

FIG. 4B schematically shows a sectional view through a detail of a further embodiment of the apparatus with a face gear as a gear wheel;

FIG. 5 schematically shows a sectional view through an embodiment of the apparatus with an externally toothed gear wheel and a coaxial, encircling coil;

FIG. 6 schematically shows a sectional view through an embodiment of the apparatus with a face gear as a gear wheel and a coaxial coil;

FIG. 7A schematically shows a sectional view through an electric motor comprising a typical embodiment of the apparatus;

FIG. 7B schematically shows a sectional view through an electric motor comprising a typical embodiment of the apparatus along line B-B of FIG. 7A; and

FIG. 8 schematically shows a typical embodiment of a method for locking or releasing a shaft of an electric motor.

### DETAILED DESCRIPTION

Typical embodiments of the invention will be described below on the basis of the figures, wherein the invention is not restricted to the exemplary embodiments; rather, the scope of the invention is determined by the claims. In the description of the embodiments, in some cases in different figures and for different embodiments, the same reference symbols are used for identical or similar parts, in order to make the description clearer. However, this does not mean that corresponding parts of the invention are restricted to the variants illustrated in the embodiments.

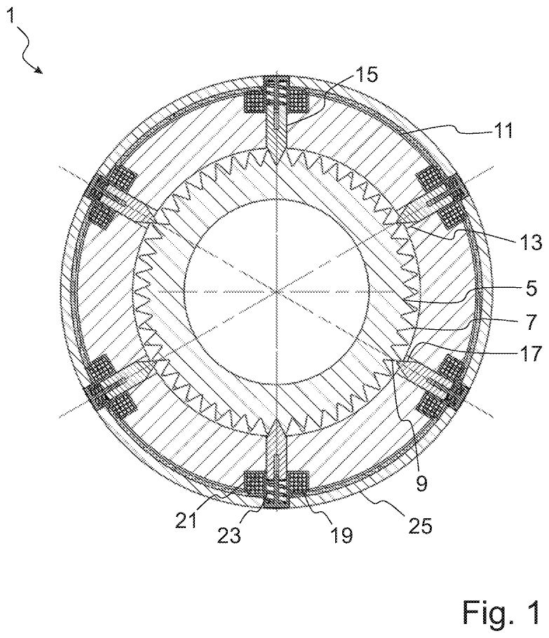

FIG. 1 schematically shows a sectional view through an apparatus 1 perpendicular to the longitudinal axis of a shaft of an electric motor. The apparatus 1 comprises a gear wheel 5 which is arranged on the shaft, a pin carrier 11 with guides 13 and pins which are arranged in the guides 13 and which are embodied as teeth 15 in FIG. 1. The gear wheel 5 of FIG. 1 is externally toothed, i.e. a tooth system 7 of the gear wheel 5 is embodied radially with respect to the longitudinal axis of the shaft of the electric motor. The guides 13 of the pin carrier 11 are likewise embodied radially with respect to the longitudinal axis of the shaft.

In FIG. 1, the teeth 15 which are arranged in the guides 13 are in an extended position and engage with the gear wheel 5 at different depths. In this case, tooth flanks 17 of the teeth 15 are in contact with flanks 9 of the tooth system 7 of the gear wheel 5, as a result of which holding torques are produced in both rotation directions of the gear wheel 5.

In FIG. 1, the guides 13 with teeth 15 arranged therein are uniformly distributed in the pin carrier 11 and are separated by regular difference angles. Here, the angle which is enclosed by two adjacent teeth 15 with respect to the center of the gear wheel 5 is referred to as the difference angle. In the exemplary embodiment of FIG. 1, the difference angle is 60° given six teeth 15 which are arranged at regular intervals in the pin carrier 11. The gear wheel 5 has a number of teeth of 50, that is to say a gear wheel pitch angle of (360/50)°. The difference angle is not an integer multiple of the gear wheel pitch angle of the gear wheel 5.

The pin carrier 11 comprises coil carriers 21 with coils 19 received therein, which coils surround the guides 13, and springs 23. The pin carrier 11 is connected in a rotationally fixed manner to a static element 25 of the electric motor, in FIG. 1 to a closure ring.

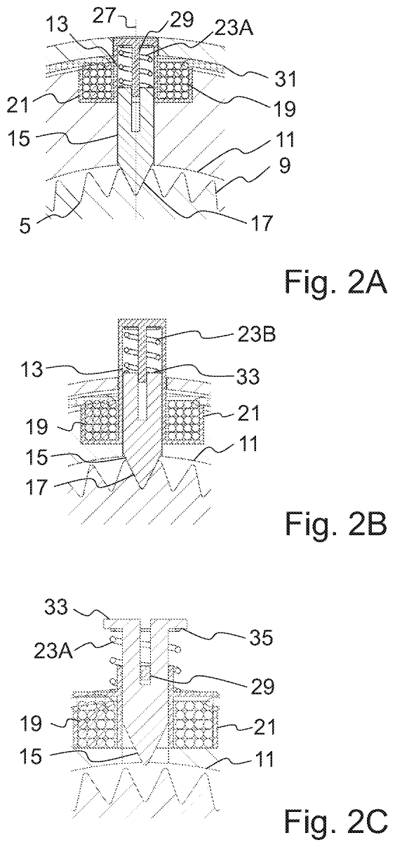

FIGS. 2A, 2B and 2C schematically show a schematic sectional view through a detail of in each case one typical embodiment of the apparatus 1 with an externally toothed gear wheel 5. However, the illustrated embodiments are not restricted to embodiments with an externally toothed gear wheel, but rather can also be transferred to embodiments with a face gear as a gear wheel in particular.

FIG. 2A shows a tooth 15 in a pin carrier 11 in engagement with a gear wheel 5, wherein tooth flanks 17 of the tooth 15 are in contact with flanks 9 of the gear wheel 5. The tooth 15 is movable along a movement axis 27 which is prespecified by a guide 13. A portion of the guide 13 of the tooth 15 in the pin carrier is provided by a coil carrier 21 of the pin carrier 11. A coil 19 which surrounds the guide 13 is received in the coil carrier 21. The coil carrier 21 comprises a rotation-prevention pin 29 which extends along the movement axis 27 of the tooth 15 and transversally to the section face of the sectional view of FIG. 2A. The rotation-prevention pin 29 can prevent rotation of the tooth 15 about the movement axis 27 of the tooth 15. In FIG. 2A, the tooth 15 is pushed to an extended position by a spring which is embodied as compression spring 23A and is received in the coil carrier 21.

The coil 19 can be supplied with electric current via a coil interconnection 31. In FIG. 2A, the coil 19 is illustrated when no current is flowing. When current is flowing through the coil 19, the tooth 15, which is produced from a ferromagnetic metal in the exemplary embodiment of FIG. 2A, can be drawn toward the coil 19 or drawn into the coil and moved to a retracted position.

FIG. 2B shows an exemplary embodiment in which the spring is embodied as a tension spring 23B. FIG. 2B shows the coil 19, which is received in the coil carrier 21, when current is flowing. When current is flowing, the tooth 15 is in the extended position and is in engagement with the gear wheel 5. When no current is flowing, the tooth 15 is drawn into the retracted position by the tension spring 23B.

In typical embodiments with a tension spring 23B as the spring, the tension spring 23B can be connected to the pin carrier 11 and to the tooth 15. In FIG. 2B, the tension spring 23B is connected to the coil carrier 21 of the pin carrier 11 and to a tooth base 33 at an end of the tooth 15, which end is situated opposite the tooth flanks 17.

In typical embodiments, the guide 13 protrudes beyond the average thickness of an annular pin carrier 11. In FIG. 2B, for example, the guide 13, which is partially formed by the coil carrier 21, is embodied to be longer than the average thickness of the annular pin carrier 11.

FIG. 2C shows an embodiment in which a tooth 15 on a tooth base 33 has a tooth projection 35. The tooth projection 35 corresponds to a widened portion of the tooth 15 on the tooth base 33. In FIG. 2C, a spring is embodied as a compression spring 23A which is supported on the pin carrier 11, in particular on the coil carrier 21 of the pin carrier 11, and on the tooth projection 35 of the tooth 15. When no current is flowing, as illustrated in FIG. 2C, the tooth 15 is pushed to a retracted position. When current is flowing through the coil 19, the tooth 15 is drawn toward the coil 19 and to the extended position.

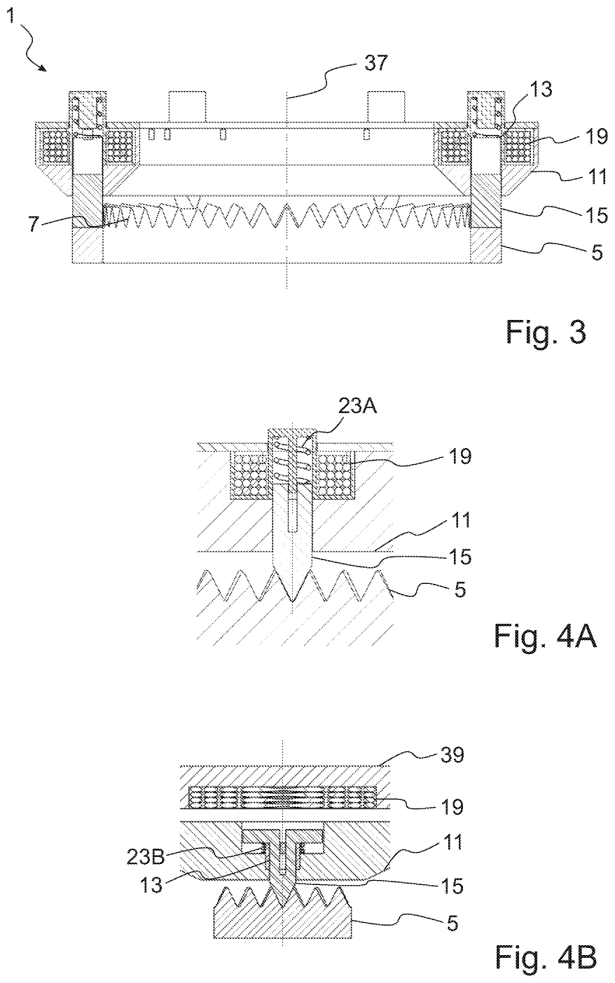

FIG. 3 schematically shows a sectional view through an embodiment of the apparatus 1 with a face gear as a gear wheel 5. In this case, the tooth system 7 of the gear wheel 5 is oriented axially with respect to a shaft axis 37, wherein the shaft axis 37 corresponds to the longitudinal axis of a shaft of an electric motor. The pin carrier 11 is arranged coaxially with the gear wheel 5 and along the shaft axis 37 in a manner offset in relation to the gear wheel 5. The sectional view of FIG. 3 runs through teeth 15 in guides 13 of the pin carrier 11, which guides are each surrounded by coils 19.

FIGS. 4A and 4B schematically show a schematic sectional view through a detail of in each case one typical embodiment of the apparatus 1 with a face gear as a gear wheel 5.

FIG. 4A shows a tooth 15 in the extended position in engagement with the gear wheel 5. In this case, the tooth 15 is pushed to the extended position by a spring which is embodied as a compression spring 23A. Current is not flowing through the coil 19 in FIG. 4A.

In FIG. 4B, a pin carrier 11 and a yoke 39 are arranged coaxially in relation to a face gear as a gear wheel 5. A tooth 15 which is held in an extended position by a spring which is embodied as a tension spring 23B is arranged in a guide 13 of the pin carrier 11. In FIG. 4B, current is not flowing through a coil 19 which is received in the yoke 39. When current is flowing through the coil 19, the tooth 15 can be drawn toward the coil 19 and moved to a retracted position.

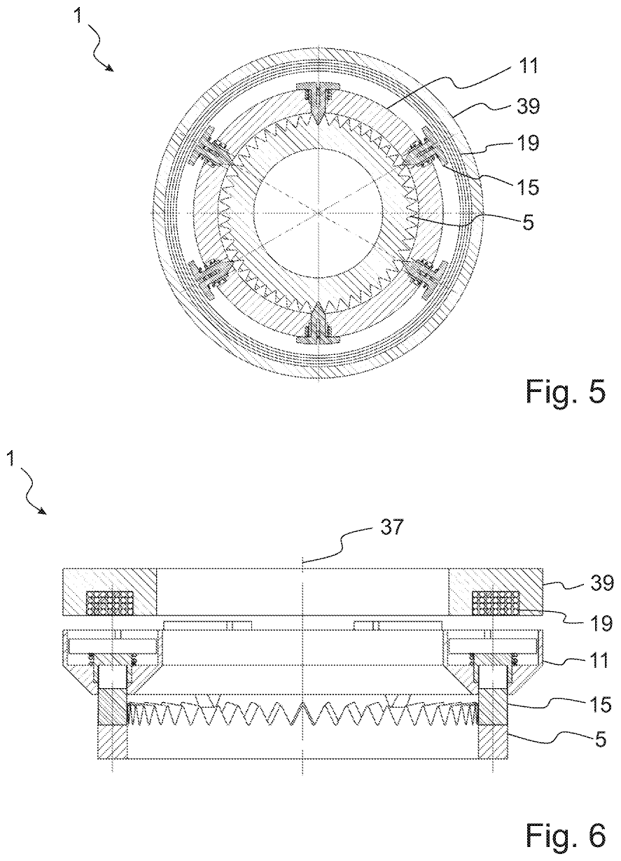

FIG. 5 schematically shows a sectional view through a further typical embodiment of the apparatus 1 with an externally toothed gear wheel 5, in particular radially movable teeth 15, and a coil 19 which is arranged coaxially in relation to a pin carrier 11. In this case, the coil 19 is fitted in a yoke 39, wherein the yoke 39 is arranged coaxially in relation to the pin carrier 11 and surrounds the pin carrier 11.

FIG. 6 schematically shows a sectional view through a further typical embodiment, wherein the gear wheel 5 is embodied as a face gear. A coil 19 which is embodied coaxially in relation to the pin carrier 11 is fitted in a yoke 39, wherein the yoke 39 is arranged coaxially in relation to the pin carrier 11 and along the shaft axis 37 in a manner offset in relation to the pin carrier 11.

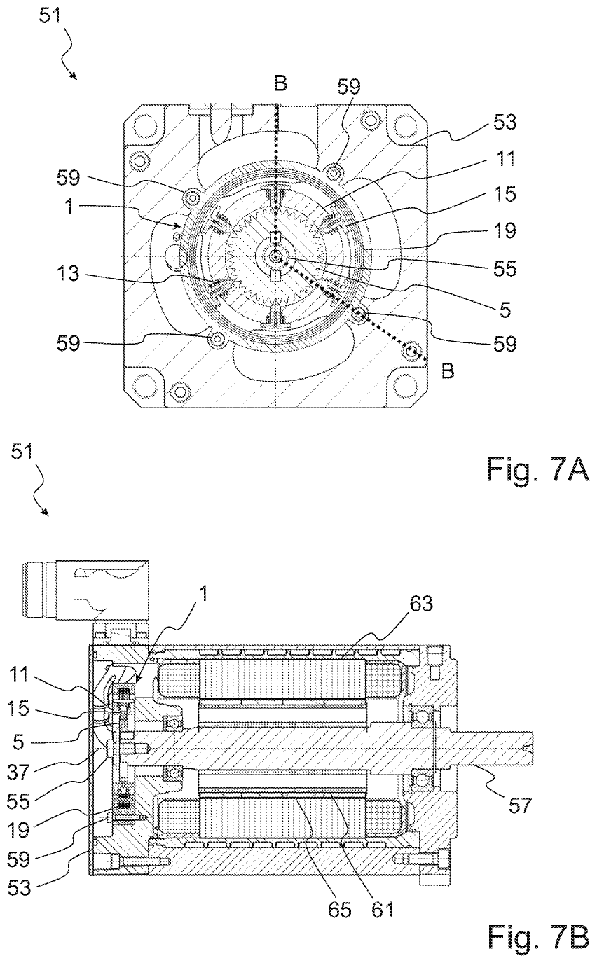

FIGS. 7A and 7B schematically show an electric motor 51 comprising an apparatus 1 according to a typical embodiment described herein with teeth with tension springs and rotation-prevention pins. Here, FIG. 7A shows a detail of a sectional view perpendicular to the shaft axis 37 of a shaft 57 of the electric motor 51 and close to the B-side end of the electric motor 51. FIG. 7B shows a sectional view through the electric motor 51 which is sectioned along a connecting line B-B in FIG. 7A. In FIG. 7A and FIG. 7B, the electric motor 51 is embodied as a permanent-magnet synchronous motor and typically has a stator 63 and permanent magnets 65 which are fastened on the shaft 57 in the region of the rotor 61.

In the exemplary embodiment of FIG. 7A, the apparatus 1 is fastened to an end plate 53 of the electric motor 51 by means of screws 59. The gear wheel 5 is connected in a rotationally fixed manner to a shaft 57, not illustrated in FIG. 7A, of the electric motor 51 by means of a clamping screw 55. A coil 19 is arranged in an encircling manner coaxially with a shaft axis 37, not illustrated in FIG. 7B, of the shaft and with the pin carrier 11. Teeth 15 are movably arranged in guides 13 of the pin carrier 11. The teeth 15 can be moved to an extended position for the purpose of locking the shaft 57 of the electric motor 51 or can be moved to a retracted position for the purpose of releasing the shaft 57 of the electric motor 51.

The sectional view of FIG. 7B shows the electric motor 51 of FIG. 7A with the gear wheel 5 which is fastened to a B-side end of the shaft 57 of the electric motor 51 by means of the clamping screw 55.

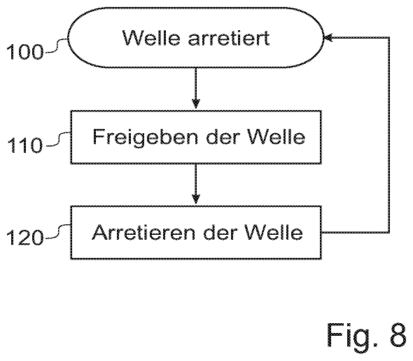

FIG. 8 schematically shows a typical embodiment of a method for locking or releasing a shaft of an electric motor using an electrically opening apparatus according to one of the embodiments described herein. In a state 100, current is not flowing through a coil of the apparatus and teeth of the apparatus are positioned in an extended position by springs. The shaft of the electric motor is locked in state 100. At 110, the shaft of the electric motor is released. In this case, a current is flowing through the coil and the teeth are moved to a retracted position and held in the retracted position on account of electrically excited magnetic fields. The shaft can now be rotated, for example can be driven by the electric motor.

At 120, the shaft of the electric motor is locked. In this case, no current is flowing through the coil and the teeth are moved to the extended position by the springs. The teeth engage into a gear wheel of the apparatus, as a result of which rotation of the shaft is prevented.

After 120, the apparatus is back in the state 100. The method can be repeated once or several times.

1. Apparatus for locking a shaft of an electric motor, comprising
a gear wheel (5) which is arranged on the shaft, at least two movable pins, and a pin carrier (11) with at least two guides (13) for in each case one pin, wherein in each case precisely one pin is received in a movable manner in at least two of the guides (13),
wherein the pin carrier (11) is formed at least substantially coaxially in relation to the shaft, and wherein the guides (13) are oriented in such a way that the pins can be positioned in a manner extended in the respective guides for engagement with the gear wheel (5).

2. Apparatus (1) according to claim 1, wherein the pins are designed as teeth (15) with tooth flanks (17).

3. Apparatus (1) according to claim 2, wherein the tooth flanks (17) of the teeth (15) are in contact with flanks (9) of a tooth system (7) of the gear wheel (5) in the event of engagement.

4. Apparatus (1) according to claim 2, wherein at least in each case one of the tooth flanks (17) of at least two of the teeth (15) are in contact with flanks (9) of the tooth system (7), wherein the at least two of the teeth (15) are in contact with the corresponding flanks (9) of the tooth system (7) in such a way that holding torques are produced in both rotation directions of the gear wheel (5).

5. Apparatus (1) according to claim 1, comprising a coil (19) which is arranged such that at least one of the teeth (15) can be moved in the respective guide (13) due to current flow in the coil (19).

6. Apparatus (1) according to claim 1, wherein all movable teeth (15) can be moved at the same time.

7. Apparatus (1) according to claim 1, wherein the guides (13), which are fitted with the teeth (15), are assigned in each case one coil (19) for moving the tooth (15) in the respective guide (13).

8. Apparatus (1) according to claim 1, wherein in each case one spring (23, 23A, 23B), which prestresses the teeth (15) in a movement direction in each case, is arranged on the guides (13) which are fitted with the teeth (15).

9. Apparatus (1) according to claim 1, comprising at least four teeth (15) which are arranged in respective guides (13).

10. Apparatus (1) according to claim 1, wherein the teeth (15) have magnetic properties.

11. Apparatus (1) according to claim 1, wherein the teeth (15) are secured against rotation about their movement axis (27).

12. Apparatus (1) according to claim 1, wherein the guides (13) are oriented radially with respect to the shaft and/or the gear wheel (5) is externally toothed.

13. Apparatus (1) according to claim 1, wherein the guides (13) are oriented parallel to the shaft and/or the gear wheel (5) is a face gear.

14. Electric motor (51) comprising an apparatus (1) according to claim 1.

15. Method for locking or releasing a shaft of an electric motor using an apparatus (1) according to claim 1 by moving the teeth.
